(19) United States
(12) Patent Application Publication
(10) Pub. No.: US 2016/0216642 A1
(43) Pub. Date: Jul. 28, 2016

(54) IMAGE FORMING UNIT AND IMAGE FORMING APPARATUS

(71) Applicant: Oki Data Corporation, Tokyo (JP)

(72) Inventor: Kazuteru KURIHARA, Tokyo (JP)

(73) Assignee: Oki Data Corporation, Tokyo (JP)

(21) Appl. No.: 14/886,856

(22) Filed: Oct. 19, 2015

(30) Foreign Application Priority Data
Jan. 28, 2015 (JP) 2015-014178

(51) Int. Cl. G03G 15/09; G03G 15/08

(52) U.S. Cl. CPC G03G 15/0921; G03G 15/0889

(57) ABSTRACT

Provided is an image forming unit that includes: a container configured to contain therein a developer that includes a toner and a magnetic carrier; a developer supporting member including a first magnetic member, and configured to support the developer; and an image supporting member including a magnetic conductive member and a photosensitive layer, and disposed to face the developer supporting member. The magnetic conductive member includes a magnetic material, and the photosensitive layer covers the magnetic conductive member and is configured to support a latent image on a surface of the photosensitive layer.

### CROSS REFERENCE TO RELATED APPLICATIONS

This application claims the benefit of Japanese Priority Patent Application JP2015-014178 filed on Jan. 28, 2015, the entire contents of which are incorporated herein by reference.

### BACKGROUND

The invention relates to an image forming unit that forms an image using an electrophotographic process, and an image forming apparatus that includes the image forming unit.

There has been proposed an image forming apparatus that uses a binary developer in which a non-magnetic toner and a magnetic carrier are mixed. For example, reference is made to Japanese Unexamined Patent Application Publication No. 2012-73317.

### SUMMARY

An image forming apparatus that uses a binary developer may result in occurrence of a disturbance in an image on a print medium, due to attachment of a magnetic carrier to an image supporting member or due to any other factor.

It is desirable to provide an image forming unit and an image forming apparatus that make it possible to form a higher-quality image.

An image forming unit according to an embodiment of the invention includes: a container configured to contain therein a developer that includes a toner and a magnetic carrier; a developer supporting member including a first magnetic member, and configured to support the developer; and an image supporting member including a magnetic conductive member and a photosensitive layer, and disposed to face the developer supporting member. The magnetic conductive member includes a magnetic material, and the photosensitive layer covers the magnetic conductive member and is configured to support a latent image on a surface of the photosensitive layer.

An image forming apparatus according to an embodiment of the invention is provided with a print medium feeder configured to feed a print medium and an image forming unit configured to form an image on the print medium fed from the print medium feeder. The image forming unit includes: a container configured to contain therein a developer that includes a toner and a magnetic carrier; a developer supporting member including a first magnetic member, and configured to support the developer; and an image supporting member including a magnetic conductive member and a photosensitive layer, and disposed to face the developer supporting member. The magnetic conductive member includes a magnetic material, and the photosensitive layer covers the magnetic conductive member and is configured to support a latent image on a surface of the photosensitive layer.

The image forming unit and the image forming apparatus according to the above-described respective embodiments of the invention make it possible to form a higher-quality image.

It is to be understood that both the foregoing general description and the following detailed description are exemplary, and are intended to provide further explanation of the invention as claimed. Also, effects of the invention are not limited to those described above. Effects achieved by the invention may be those that are different from the above-described effects, or may include other effects in addition to those described above.

### BRIEF DESCRIPTION OF THE DRAWINGS

FIG. 1 schematically illustrates an example of a configuration of an image forming unit according to an example embodiment of the invention.

FIG. 2 schematically illustrates an essential part of the image forming unit illustrated in FIG. 1 in an enlarged manner.

FIG. 3 schematically illustrates an example of an overall configuration of an image forming apparatus that includes the image forming unit illustrated in FIG. 1.

FIG. 4 is a block diagram schematically illustrating an example of a configuration inside the image forming apparatus illustrated in FIG. 3.

FIG. 5 is a flowchart illustrating an example of an operation of controlling a toner concentration in the image forming unit illustrated in FIG. 1.

FIG. 6 schematically illustrates a print pattern according to Example.

### DETAILED DESCRIPTION

In the following, some example embodiments of the invention are described in detail, in the following order, with reference to the accompanying drawings. Note that the following description is directed to illustrative examples of the invention and not to be construed as limiting to the invention. Also, factors including, without limitation, arrangement, dimensions, and a dimensional ratio of elements illustrated in each drawing are illustrative only and not to be construed as limiting to the invention.

1. Example Embodiment, directed to an image forming unit and an image forming apparatus in each of which a magnetic metal pipe may be used for an image supporting member.

### 2. Example

### 1. Example Embodiment

### [Configuration of Image Forming Unit 1]

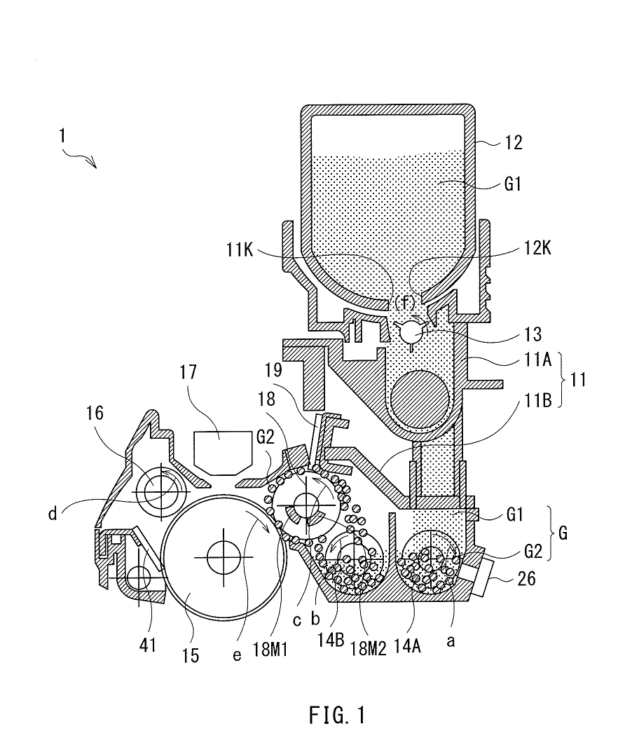

FIG. 1 schematically illustrates an example of an outline configuration of an image forming unit 1 according to an example embodiment of the invention. The image forming unit 1 may form a toner image using a toner G1, and may be mounted on an electrophotographic image forming apparatus. For example, the image forming apparatus may form an image, which may be a color image, on a recording medium. The recording medium may also be referred to as a “print medium” or a “transfer member”, and may be, for example but not limited to, paper.

In this disclosure, a direction in which the recording medium travels is referred to as a “conveying direction”, and a direction orthogonal to the conveying direction, i.e., a direction perpendicular to the drawing of FIG. 1, is referred to as a “lateral direction”. Further, in this disclosure, a dimension in the lateral direction is referred to as a “width”.

The toner G1 may be configured by non-magnetic materials including: a binder resin; a charge control agent, a release agent, and a colorant that serve as internal additives; and an external additive. The binder resin may be, for example but not limited to, a polyester resin. The external additive may be, for example but not limited to, silica or a titanium oxide. Among these materials, a color of the colorant may be selected on an as-needed basis to change a color of the toner image to be formed by the image forming unit 1.

Referring to FIG. 1, the image forming unit 1 may include a main section 11 and a toner cartridge 12. The main section 11 may have a first section 11A and a second section 11B. The toner cartridge 12 may be adapted to be attached to the main section 11. The toner cartridge 12 is a container configured to contain therein the toner G1, and may have a toner outlet 12K at a lower part thereof. The first section 11A may have a toner inlet 11K at a position that faces the toner outlet 12K, and may be provided therein with a space through which the toner G1 passes. Near the toner inlet 11K in the first section 11A is a toner feeding shutter 13 that may be provided with an unillustrated clutch and may be rotated to open and close the toner inlet 11K. Bringing the toner feeding shutter 13 into an open state allows the toner G1 contained in the toner cartridge 12 to be fed into the first section 11A.

The second section 11B may have developer conveyor screws 14A and 14B, a photoreceptor drum 15, a charging roller 16, a light-emitting diode (LED) head 17, a developing sleeve 18, a doctor blade 19, a cleaning blade 41, and a toner concentration sensor 26. The developing sleeve 18 may serve a developer supporting member. The second section 11B may contain therein a magnetic carrier (magnetic particles) G2 adapted to support the toner G1. The magnetic carrier G2 may be mixed, at the inside of the second section 11B, with the toner G1 by the developer conveyor screws 14A and 14B. The magnetic carrier G2 may be magnetic powder or magnetic particles. The magnetic carrier G2 may be made of, for example but not limited to: a metal such as iron (Fe), nickel (Ni), cobalt (Co), manganese (Mn), chromium (Cr), and a rare-earth element including neodymium (Nd) and samarium (Sm); an alloy of any combination thereof; or an oxide ferrite. A mixture of the toner G1 and the magnetic carrier G2 is referred to as a developer G. The second section 11B corresponds to a concrete but non-limiting example of a “container” in one embodiment of the invention.

The developer conveyor screws 14A and 14B may be driven to rotate by means of drive force. The drive force may be supplied from a later-described drive transmission section 30 and transmitted to the developer conveyor screws 14A and 14B through unillustrated gears. The rotated developer conveyor screws 14A and 14B mix and stir the toner G1 and the magnetic carrier G2 to form the developer G, and convey the thus-formed developer G to the developing sleeve 18. The developer G may be conveyed from the developer conveyor screw 14A through the developer conveyor screw 14B to the developing sleeve 18. The developer conveyor screw 14B may be disposed close to a surface (a circumferential surface) of the developing sleeve 18. In the example embodiment illustrated in FIG. 1, the developer conveyor screw 14A may be rotated clockwise as denoted by an arrow “a” in FIG. 1, and the developer conveyor screw 14B may be rotated anticlockwise as denoted by an arrow “b” in FIG. 1. The developer conveyor screws 14A and 14B correspond to a concrete but non-limiting example of a “stirring member” in one embodiment of the invention.

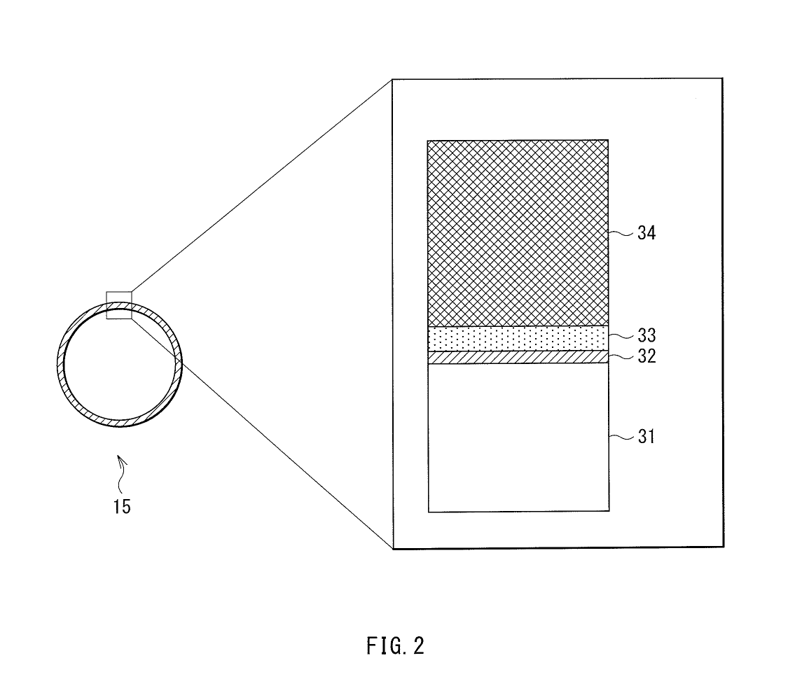

The photoreceptor drum 15 may be a cylindrical member that extends in the lateral direction, and may include a photoreceptor which may be, for example but not limited to, an organic photoreceptor. The photoreceptor drum 15 may serve as an electrostatic latent image supporting member that supports an electrostatic latent image on a surface (a superficial part) of the photoreceptor drum 15. Referring to FIG. 2, the photoreceptor drum 15 includes a conductive supporting member 31, and a photoconductive layer that covers an outer circumference part (a surface) of the conductive supporting member 31. The conductive supporting member 31 may be a metal pipe made of a magnetic material such as, but not limited to, a ferrite-based stainless steel (a non-limiting example of which may be SUS430). The photoconductive layer may have a configuration in which an underlayer 32, a charge generating layer 33, and a charge transporting layer 34 are stacked in order on the conductive supporting member 31, for example. The photoreceptor drum 15 may further include an overcoat layer on the charge transporting layer 34 to improve durability of the photoreceptor drum 15. The thus-configured photoreceptor drum 15 may be rotated at a predetermined circumferential velocity (may be rotated clockwise as denoted by an arrow “e” in FIG. 1 in this example embodiment) by means of a later-described drive motor 29 controlled by a later-described drive control section 29S. In one embodiment of the invention, the photoreceptor drum 15 corresponds to a concrete but non-limiting example of an “image supporting member”, and the electrostatic latent image corresponds to a concrete but non-limiting example of a “latent image”. The conductive supporting member 31 corresponds to a concrete but non-limiting example of a “magnetic conductive member” in one embodiment of the invention.

The charging roller 16 may be a member (i.e., a charging member) that charges the surface (the superficial part) of the photoreceptor drum 15, and may be so disposed as to be in contact with the surface (a circumferential surface) of the photoreceptor drum 15. The charging roller 16 may include a metal shaft, and a semi-conductive rubber layer that covers an outer circumference part (a surface) of the metal shaft, for example. The semi-conductive rubber layer may be, for example but not limited to, a semi-conductive epichlorohydrin rubber layer. In the example embodiment, the charging roller 16 may be rotated anticlockwise, i.e., rotated in an opposite direction to the photoreceptor drum 15, as denoted by an arrow “d” in FIG. 1. The charging roller 16 corresponds to a concrete but non-limiting example of a “charging unit” in one embodiment of the invention.

The developing sleeve 18 may be a member that supports the toner G1, adapted to develop the electrostatic latent image, on a surface of the developing sleeve 18, and may be so disposed, while facing the photoreceptor drum 15, as to be separated away from the photoreceptor drum 15. The developing sleeve 18 may form a gap of about 450 μm without limitation between the developing sleeve 18 and the surface (the circumferential surface) of the photoreceptor drum 15. The developing sleeve 18 may include a metal shaft, and a semi-conductive rubber layer that covers an outer circumference part (a surface) of the metal shaft. The metal shaft may have a surface having been subjected to a blast finishing, for example. The semi-conductive rubber layer may be, for example but not limited to, a semi-conductive urethane rubber layer. The metal shaft may be provided therein with two ferromagnetic members 18M1 and 18M2 each may be, for example but not limited to, a permanent magnet. The ferromagnetic member 18M1 may form, near the surface of the developing sleeve 18 that faces the photoreceptor drum 15, a magnetic field distribution that attracts the magnetic carrier G2 to the surface of the developing sleeve 18. In contrast, the ferromagnetic member 18M2 may form, near the surface of the developing sleeve 18 that faces the developer conveyor screw 14B, a magnetic field distribution that attracts the magnetic carrier G2 away from the surface of the developing sleeve 18. In other words, the ferromagnetic member 18M1 may indicate a first polarity (for example but not limited to, a south (S) pole) at a position that faces the photoreceptor drum 15, whereas the ferromagnetic member 18M2 may indicate a second polarity opposite to the first polarity (for example but not limited to, a north (N) pole) at a position that faces the developer conveyor screw 14B. The thus-configured developing sleeve 18 may be rotated at a predetermined circumferential velocity (may be rotated anticlockwise, i.e., in the opposite direction to the photoreceptor drum 15, as denoted by an arrow “c” in FIG. 1 in the example embodiment). Positions of the respective ferromagnetic members 18M1 and 18M2 may be fixed irrespective of the rotation of the developing sleeve 18. In one embodiment of the invention, the developing sleeve 18 corresponds to a concrete but non-limiting example of a “developer supporting member”. The ferromagnetic member 18M1 corresponds to a concrete but non-limiting example of a “first magnetic member”, and the ferromagnetic member 18M2 corresponds to a concrete but non-limiting example of a “second magnetic member” in one embodiment of the invention.

The LED head 17 may be an exposure unit that performs exposure of the surface of the photoreceptor drum 15 to form the electrostatic latent image on the surface (the superficial part) of the photoreceptor drum 15. The LED head 17 may include a plurality of LED light emitting sections that are arrayed in the lateral direction relative to the corresponding photoreceptor drum 15. In one embodiment of the invention, the LED head 17 corresponds to a concrete but non-limiting example of an “exposure unit”.

The doctor blade 19 may be a toner regulating member that forms a layer made of the toner G1 (i.e., a toner layer) on the surface of the rotating developing sleeve 18 while regulating (controlling or adjusting) a thickness of the toner layer. The doctor blade 19 may be a plate-shaped elastic member (a plate spring) which may be made of, for example but not limited to, a stainless steel, and may be so disposed that a tip of the plate-shaped elastic member comes into slight contact with the surface of the developing sleeve 18.

The cleaning blade 41 may be a member that scrapes the toner G1 remaining on the surface (the superficial part) of the photoreceptor drum 15 to clean the surface of the photoreceptor drum 15. The cleaning blade 41 may be so disposed to counter-face the photoreceptor drum 15 as to come into contact with the surface of the photoreceptor drum 15, i.e., so disposed as to protrude in a direction opposite to the direction of rotation of the photoreceptor drum 15. The cleaning blade 41 may be made of an elastic body such as, but not limited to, a polyurethane rubber.

The toner concentration sensor 26 may be a device that detects a concentration of the toner G1 in the developer G The toner concentration sensor 26 may be, for example but not limited to, a magnetic-permeability-detection toner concentration sensor.

### [Configuration of Image Forming Apparatus]

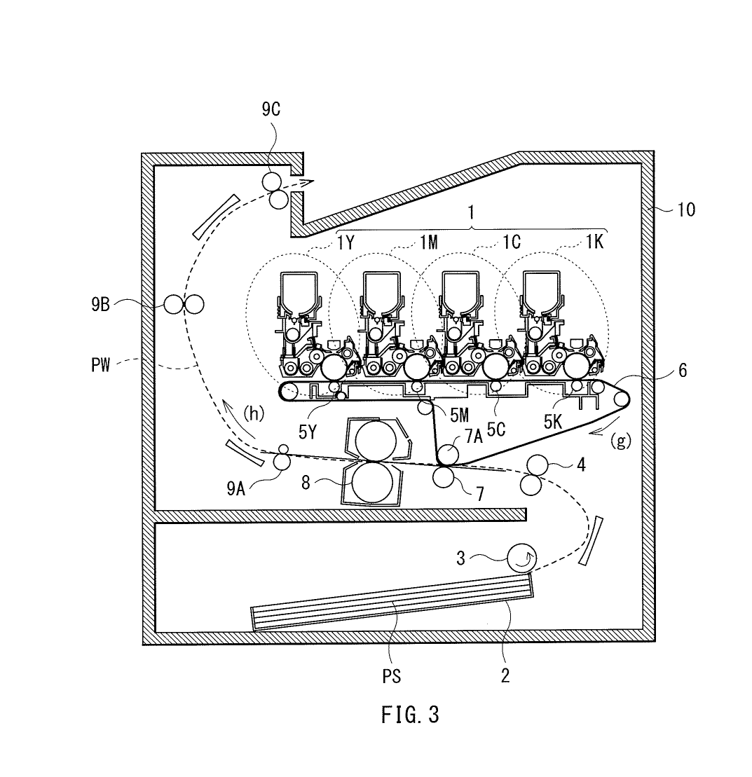

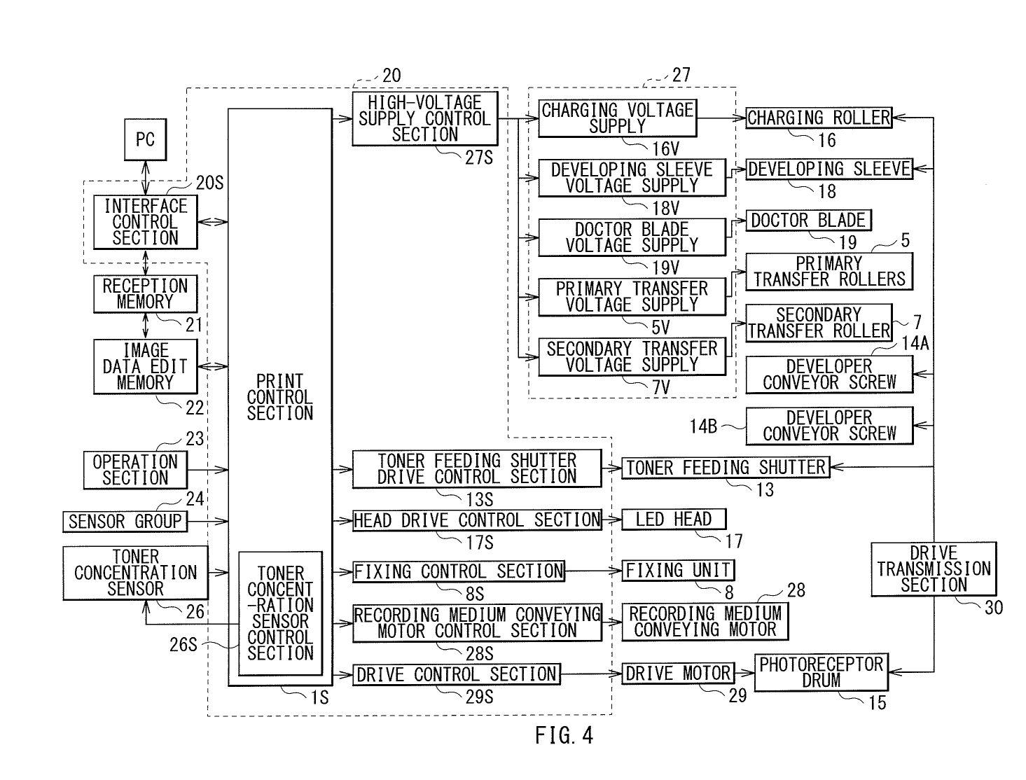

FIG. 3 schematically illustrates an example of an overall configuration of an image forming apparatus that includes the image forming units 1Y, 1M, 1C, and 1K. FIG. 4 is a block diagram corresponding to the image forming apparatus illustrated in FIG. 3. The image forming apparatus may be, without limitation, an electrophotographic printer that forms an image, which may be a color image, on a recording medium PS. The recording medium PS may also be referred to as a “print medium” or a “transfer member”, and may be, for example but not limited to, paper.

The image forming units 1Y, 1M, 1C, and 1K in the image forming apparatus each may have a configuration same as the configuration of the image forming unit 1 described above, with the exception that the image forming unit 1Y uses a yellow (Y) toner to form a yellow toner image, and the image forming unit 1M uses a magenta (M) toner to form a magenta toner image. Likewise, the image forming unit 1C uses a cyan (C) toner to form a cyan toner image, and the image forming unit 1K uses a black (K) toner to form a black toner image.

Referring to FIG. 3, besides the image forming unit 1, i.e., the image forming units 1Y, 1M, 1C, and 1K, the image forming apparatus may include, inside a housing 10, members such as a medium feeding tray (a paper feeding tray) 2, a medium feeding roller (a paper feeding roller) 3, a pair of conveying rollers 4, primary transfer rollers 5 (5Y, 5M, 5C, and 5K), an intermediate transfer belt 6, a secondary transfer roller 7, a fixing unit 8, and pairs of conveying rollers 9A to 9C. The medium feeding tray 2 may store the recording medium PS.

The medium feeding tray 2 may be a member that stores the recording medium PS in a stacked fashion, and may be so provided at a lower part of the image forming apparatus as to be attachable to and detachable from the image forming apparatus.

The medium feeding roller 3 may be a member that takes the recording medium PS stored in the medium feeding tray 2 out of the medium feeding tray 2 one by one from the top, and feeds the taken out recording medium PS towards the pair of conveying rollers 4.

The pair of conveying rollers 4 may be members that correct skew of the recording medium PS fed from the medium feeding roller 3, and convey the skew-corrected recording medium PS to a secondary transfer section in which the intermediate transfer belt 6 and the secondary transfer roller 7 are opposed to each other.

The primary transfer rollers 5Y, 5M, 5C, and 5K may be members that electrostatically transfer the toner images, formed in the respective image forming units 1Y, 1M, 1C, and 1K, onto a surface of the intermediate transfer belt 6. The primary transfer rollers 5Y, 5M, 5C, and 5K may be respectively disposed to oppose the image forming units 1Y, 1M, 1C, and 1K through the intermediate transfer belt 6. The primary transfer rollers 5Y, 5M, 5C, and 5K each may be, for example but not limited to, a foamed semi-conductive elastic rubber member. Also, the primary transfer rollers 5Y, 5M, 5C, and 5K each may be applied with a predetermined voltage, or an applied voltage Va0, by a later-described primary transfer voltage supply 5V as illustrated in FIG. 3. The applied voltage Va0 may be a bias voltage having a polarity reverse to a polarity of each of the toners having respective colors. For example, the toners each may have a negative polarity (the same applies to the following description), and the applied voltage Va0 may thus have a positive polarity. In an alternative embodiment, however, the applied voltage Va0 may be a bias voltage that has the same polarity (for example, the negative polarity) as each of the toners.

The intermediate transfer belt 6 may be a member that may be rotated clockwise as denoted by an arrow “g” in FIG. 3. The rotation of the intermediate transfer belt 6 may cause the recording medium PS conveyed from the pair of conveying rollers 4 to be conveyed further downstream of the pair of conveying rollers 4, and allow the toner images formed by the respective image forming units 1Y, 1M, 1C, and 1K to be sequentially transferred, as a primary transfer, onto the surface of the intermediate transfer belt 6 along a direction of rotation of the intermediate transfer belt 6. The intermediate transfer belt 6 may be an elastic endless belt made of a resin material such as, but not limited to, a polyimide resin.

The secondary transfer roller 7 may be so disposed as to interpose the intermediate transfer belt 6 between the secondary transfer roller 7 and a backup roller 7A. The secondary transfer roller 7 may include a core and an elastic layer so formed as to be wound around an outer circumferential face of the core. For example, the core may be made of a metal. The elastic layer may be, for example but not limited to, a foamed rubber layer. The backup roller 7A and the secondary transfer roller 7 may structure the secondary transfer section that performs a secondary transfer, onto the recording medium PS, of the toner images having been subjected to a primary transfer onto the surface of the intermediate transfer belt 6.

The backup roller 7A and the secondary transfer roller 7 may perform a transfer, or the secondary transfer, of the toner images onto the recording medium PS fed from the pair of conveying rollers 4. Upon the secondary transfer, a transfer bias voltage (a direct-current voltage) may be applied to the secondary transfer roller 7, generating a potential difference between the secondary transfer roller 7 and the backup roller 7A. The generation of the potential difference causes the toner images to be transferred onto the recording medium PS. Referring to FIG. 4, a secondary transfer voltage supply 7V may operate based on a control received from a high-voltage supply control section 27S, and supply the transfer bias voltage to the secondary transfer roller 7.

The fixing unit 8 may be a member that applies heat and pressure to the toner images having been subjected to the secondary transfer onto the recording medium PS to fix the toner images to the recording medium PS. The fixing unit 8 may operate based on an operation control received from a fixing control section 8S as illustrated in FIG. 4.

The pairs of conveying rollers 9A to 9C each may be a member that conveys the recording medium PS, to which the toners have been fixed by the fixing unit 8, in a direction denoted by an arrow “h” in FIG. 3 to discharge the recording medium PS onto a discharge tray provided outside the image forming apparatus.

Further, as illustrated in FIG. 4, the image forming apparatus may include a control section 20, a reception memory 21, an image data edit memory 22, an operation section 23, a sensor group 24, and a power supply circuit 27. The control section 20 may include an interface (I/F) control section 20S, a print control section 1S, a toner concentration sensor control section 26S, the high-voltage supply control section 27S, a toner feeding shutter drive control section 13S, a head drive control section 17S, the fixing control section 8S, a recording medium conveying motor control section 28S, and the drive control section 29S. The power supply circuit 27 may include a charging voltage supply 16V, a developing sleeve voltage supply 18V, a doctor blade voltage supply 19V, the primary transfer voltage supply 5V, and the secondary transfer voltage supply 7V. The image forming apparatus may further include a recording medium conveying motor 28, the drive motor 29, and the drive transmission section 30. The recording medium conveying motor 28 may drive the medium feeding roller 3. The drive motor 29 may drive the photoreceptor drum 15. The drive transmission section 30 may transmit the drive force derived from the drive motor 29 to the charging roller 16, the developing sleeve 18, the developer conveyor screws 14A and 14B, and the toner feeding shutter 13.

The I/F control section 20S may receive print data and a control command from an external device such as, but not limited to, a personal computer (PC), and may transmit a signal on a state of the image forming apparatus.

The reception memory 21 may temporarily hold the print data received through the I/F control section 20S from the external device including the PC. The image data edit memory 22 may receive the print data held in the reception memory 21 and store image data as the edited print data. The operation section 23 may have an LED lamp for displaying the state of the image forming apparatus and an input section including a button and a touch panel for allowing a user to give instructions to the image forming apparatus. The sensor group 24 may include various sensors that monitor operation states of the image forming apparatus, such as a recording medium position detection sensor, a temperature-humidity sensor, a print density sensor, and a toner remaining amount detection sensor.

The print control section 1S may receive the print data and the control command from the I/F control section 20S, and perform an overall control of the toner concentration sensor control section 26S, the high-voltage supply control section 27S, the toner feeding shutter drive control section 135, the head drive control section 175, the fixing control section 8S, the recording medium conveying motor control section 28S, and the drive control section 29S. The toner concentration sensor control section 26S may control a control voltage of the toner concentration sensor 26 to adjust sensitivity of the toner concentration sensor 26. The high-voltage supply control section 27S may control a voltage to be applied to each of the power supplies that structure the power supply circuit 27, based on instructions given from the print control section 1S. The toner feeding shutter drive control section 13S may control opening and closing operations of the toner feeding shutter 13. The toner feeding shutter drive control section 13S may so perform a control as to cause the toner G1 to be fed to the main section 11 of the image forming unit 1 in accordance with the concentration of the toner G1 in the developer G detected by the toner concentration sensor 26. The head drive control section 17S may send the image data recorded in the image data edit memory 22 to the LED head 17, and perform a drive control of the LED head 17. The fixing control section 8S may control a voltage to be applied to the fixing unit 8 when the toner images having been transferred onto the recording medium PS are to be fixed to the recording medium PS. The recording medium conveying motor control section 28S may perform an operation control of the recording medium conveying motor 28 when the recording medium PS is to be conveyed by the medium feeding roller 3. The drive control section 29S may perform an operation control of the drive motor 29.

The charging voltage supply 16V, the developing sleeve voltage supply 18V, the doctor blade voltage supply 19V, the primary transfer voltage supply 5V, and the secondary transfer voltage supply 7V may apply their respective voltages that are based on instructions given from the high-voltage supply control section 27S to the charging roller 16, the developing sleeve 18, the doctor blade 19, the primary transfer rollers 5, and the secondary transfer roller 7, respectively.

### [Action and Effect]

### [A. Basic Operation]

In the foregoing image forming apparatus, the toner images may be transferred onto the recording medium PS as follows.

When print image data and a print command are supplied from the external device including the PC to the image forming apparatus that has been started up, the print control section 1S may receive the print image data and the print command therefrom via the I/F control section 20S. Upon receiving the print image data and the print command, the print control section 1S may start a print operation of the print image data in conjunction with the drive control section 29S and any other control section, in accordance with the received print command.

The drive control section 29S may drive the drive motor 29 to rotate the photoreceptor drum 15 at a constant velocity in the direction denoted by the arrow “e” as illustrated in FIG. 1. The rotation of the photoreceptor drum 15 may cause the drive force thereof to be transmitted to each of the developer conveyor screws 14A and 14B, the developing sleeve 18, and the charging roller 16 through the drive transmission section 30 that may include a gear train and so forth. This may result in the rotation of the developer conveyor screws 14A and 14B, the developing sleeve 18, and the charging roller 16 in their respective directions denoted by the arrows “a” to “d” as illustrated in FIG. 1.

Also, the high-voltage supply control section 27S may cause a predetermined voltage to be applied to the charging roller 16 from the charging voltage supply 16V to uniformly charge the surface of the photoreceptor drum 15.

Then, the head drive control section 17S may start up the LED head 17, and cause the LED head 17 to irradiate the corresponding photoreceptor drum 15 with light that corresponds to a color component of a print image that is based on an image signal, to thereby form the electrostatic latent image on the surface of the corresponding photoreceptor drum 15. Further, in the image forming unit 1, the development of the toner G1 may be performed as follows on the electrostatic latent image formed on the surface of the corresponding photoreceptor drum 15.

First, the toner feeding shutter 13 may be rotated to feed the toner G1 into the first section 11A of the main section 11 through the toner inlet 11K from the toner outlet 12K of the toner cartridge 12. Here, the rotation of the photoreceptor drum 15 may cause the drive force thereof to be transmitted to the toner feeding shutter 13 through the drive transmission section 30 as well. Hence, the toner feeding shutter 13 may be rotated in a predetermined direction as well when the clutch is operated in response to instructions given from the toner feeding shutter drive control section 13S. Controlling the rotation of the toner feeding shutter 13 by the toner feeding shutter drive control section 13S allows a desired amount of toner G1 to be fed into the first section 11A.

The toner G1 may be introduced from the first section 11A into the second section 11B where the toner G1 may be mixed with the magnetic carrier G2 and stirred by the developer conveyor screws 14A and 14B to form the developer G. Here, the toner concentration sensor control section 26S may cause the toner concentration detected by the toner concentration sensor 26 to be kept constant, as described later in greater detail.

The developer G stirred sequentially by the developer conveyor screws 14A and 14B may be drawn to the developing sleeve 18 by means of magnetic force derived from the ferromagnetic member 18M2. The developer G drawn to the developing sleeve 18 may form a magnetic brush according to a magnetic flux density of a magnetic field present on the surface of the developing sleeve 18. The magnetic brush refers to the magnetic carriers G2 that are each attached with the toner G1 and are coupled to each other in chains by means of the magnetic force. The magnetic brush may move along with the rotation of the developing sleeve 18 and may be cut to any appropriate length by the doctor blade 19. The developing sleeve 18 and the doctor blade 19 may be at the same potential as each other (for example, may be at minus (−) 500 V). Alternatively, a potential difference may be provided between the developing sleeve 18 and the doctor blade 19. The magnetic brush having been cut to any appropriate length may further move along with the rotation of the developing sleeve 18 to reach a gap region between the developing sleeve 18 and the photoreceptor drum 15. At the gap region, the toner G1 having been charged to, for example but not limited to, the negative potential may be subjected to the development according to the electrostatic latent image on the photoreceptor drum 15 to form the toner image on the photoreceptor drum 15. In other words, the toner G1 may leave the developing sleeve 18 and move to the photoreceptor drum 15 by means of Coulomb's force, due to a non-magnetic property of the toner G1 which prevents the toner G1 from being influenced by the magnetic force of each of the ferromagnetic members 18M1 and 18M2. In contrast, the magnetic carrier G2 in the developer G may be susceptible to the magnetic force of the ferromagnetic member 18M1 and thus fail to leave the developing sleeve 18. In the example embodiment, the conductive supporting member 31 of the photoreceptor drum 15 is made of the magnetic material, allowing the conductive supporting member 31 to be magnetized by the ferromagnetic member 18M1. This increases the magnetic flux density of the magnetic field derived from the ferromagnetic member 18M1 at the gap region between the developing sleeve 18 and the photoreceptor drum 15, making it possible to prevent the magnetic carrier G2 from leaving the developing sleeve 18 to move to the photoreceptor drum 15. The magnetic carrier G2 having travelled through the gap region between the developing sleeve 18 and the photoreceptor drum 15 may reach a region near the ferromagnetic member 18M2 with the rotation of the developing sleeve 18, followed by detachment from the surface of the developing sleeve 18 by means of the magnetic force of the ferromagnetic member 18M2. The magnetic carrier G2 detached from the surface of the developing sleeve 18 may be mixed with the toner G1 and stirred with the developer conveyor screw 14B again.

Each of the primary transfer rollers 5, so provided as to face the corresponding photoreceptor drum 15, may be applied with the predetermined voltage by the primary transfer voltage supply 5V to perform the transfer, or the primary transfer, of the toner images formed on the respective photoreceptor drums 15 onto the surface of the intermediate transfer belt 6 that travels through regions between the photoreceptor drums 15 and their respective corresponding primary transfer rollers 5.

Then, the recording medium conveying motor control section 28S may start up the recording medium conveying motor 28 to initiate conveying of the recording medium PS. This conveying control may cause the recording medium PS to be conveyed at a predetermined conveying speed to the secondary transfer section in which the backup roller 7A and the secondary transfer roller 7 are opposed to each other. More specifically, as illustrated in FIG. 3, the recording medium PS stored in the medium feeding tray 2 may be taken out of the medium feeding tray 2, one by one from the top, by the medium feeding roller 3 to be delivered towards the pair of conveying rollers 4. The recording medium PS delivered from the medium feeding roller 3 may be conveyed to the secondary transfer section while being subjected to the skew correction by the pair of conveying rollers 4.

Thereafter, the secondary transfer roller 7 may be applied with a predetermined voltage by the secondary transfer voltage supply 7V to perform the transfer, or the secondary transfer, of the toner images formed on the surface of the intermediate transfer belt 6 onto the recording medium PS that passes through the secondary transfer section.

Thereafter, heat and pressure may be applied to the toner images transferred onto the recording medium PS to fix the toner images to the recording medium PS in the fixing unit 8. The recording medium PS to which the toner images are fixed may travel through the pairs of conveying rollers 9A to 9C to be discharged to the outside. In some cases, the toner G1 failed to be transferred onto the recording medium PS may remain slightly on the photoreceptor drum 15. Such a remaining toner G1, however, may be removed by the cleaning blade 41, making it possible to use the photoreceptor drum 15 continuously.

### [B. Method of Controlling Toner Concentration]

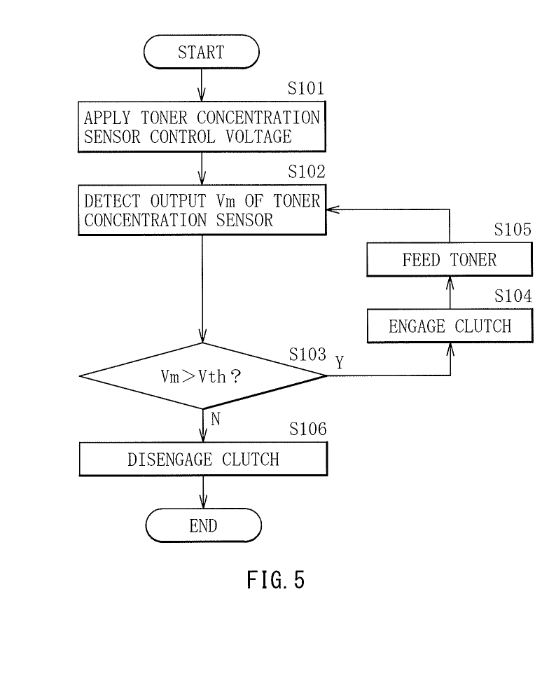

A description is given, with reference to FIG. 5, of a method of controlling the toner concentration in the image forming unit 1 according to the example embodiment. When the print operation is started by the print control section 1S, the toner concentration sensor control section 26S may apply a toner concentration sensor control voltage to the toner concentration sensor 26 (step S101). The toner concentration sensor 26 applied with the toner concentration sensor control voltage may detect a detection output Vm (step S102). The detection output Vm varies depending on the magnetic permeability of the developer G. For example, a decrease in the concentration of the toner G1 contained in the developer G to be measured by the toner concentration sensor 26 results in an increase in the magnetic permeability, which in turn increases the detection output Vm. The toner concentration sensor 26 may continuously detect the detection output Vm from the start of the print operation to the end of the print operation. When the detection output Vm exceeds a preset threshold voltage Vth, (Y of step S103), the toner feeding shutter drive control section 13S may instruct the toner feeding shutter 13 to bring the clutch of the toner feeding shutter 13 into engagement (step S104). For example, this may rotate the toner feeding shutter 13 in a direction denoted by an arrow “f” in FIG. 1, allowing the toner G1 to be fed into the main section 11 (step S105). Thereafter, when the detection output Vm becomes equal to or less than the threshold voltage Vth, or when the detection output Vm is equal to or less than the threshold voltage Vth from the beginning (N of step S103), the toner feeding shutter drive control section 13S may issue instructions to disengage the clutch of the toner feeding shutter 13, i.e., to bring the clutch into a disconnected state (step S106). This prevents the feeding of the toner G1 from the toner cartridge 12 into the main section 11 from being performed. The foregoing operation allows for a control that causes the toner G1 in the developer G in the image forming unit 1 to be constant in toner concentration or to be close to constant in toner concentration.

### [C. Action and Effect of Image Forming Apparatus]

The image forming unit 1 according to the example embodiment includes the developing sleeve 18 and the photoreceptor drum 15. The developing sleeve 18 includes the ferromagnetic member 18M1, and the photoreceptor drum 15 is disposed to face the developing sleeve 18 and includes the conductive supporting member 31 made of the magnetic material. This causes the conductive supporting member 31 to be magnetized by means of a magnetic flux derived from the ferromagnetic member 18M1, making it possible to increase the magnetic flux density at the gap region between the developing sleeve 18 and the photoreceptor drum 15. Hence, the magnetic carrier G2 is supported on the surface of the developing sleeve 18 by the magnetic force of the ferromagnetic member 18M1 without causing attachment to the photoreceptor drum 15 to be collected by the second section 11B. In contrast, the non-magnetic toner G1 having been held by the magnetic carrier G2 is less susceptible to the magnetic force of the ferromagnetic member 18M1 and thus may be attached to the photoreceptor drum 15 by means of Coulomb's force to be subjected to the development at a predetermined position. As a result, it is possible for the image forming apparatus to form a higher-quality image. In other words, the attachment of the magnetic carrier G2 on the photoreceptor drum 15 may result in occurrence of a print detect in the recording medium PS to be subjected to the transfer, such as, but not limited to, generation of voids in a print region and an unintended attachment of the toner G1 in a non-print region; however, the image forming apparatus according to the example embodiment makes it possible to prevent such a print defect. Also, the attachment of the magnetic carrier G2 on the photoreceptor drum 15 may raise a concern that the surface of the photoreceptor drum 15 is damaged; however, the image forming apparatus according to the example embodiment makes it possible to solve such a concern as well.

### 2. Example

In the following, one Example of the image forming apparatus is described. It should be understood that the Example described below is illustrative, and should not be construed as being limiting in any way.

### Example

As an Example, an image forming apparatus was fabricated that included the photoreceptor drum 15 that had the conductive supporting member 31 made of SUS430.

### Comparative Example

As a Comparative Example, an image forming apparatus was fabricated that included the photoreceptor drum 15 that had the conductive supporting member 31 made of aluminum.

### [Experiment 1]

A measurement was performed for each of the Example and the Comparative Example described above on a magnetic flux density of a magnetic flux generated at the gap region between the photoreceptor drum 15 and the developing sleeve 18. The measurement was performed using a Gauss meter “GM-5015” available from Denshijiki Industry Co., Ltd. located in Tokyo, Japan, where the gap between the photoreceptor drum 15 and the developing sleeve 18 was 100 μm. In addition thereto, a measurement was also performed as a Reference Example on a magnetic flux density of a magnetic flux near the surface of the developing sleeve 18, where no photoreceptor drum 15 was provided. Table 1 shows results of the measurements.

TABLE 1

| | Magnetic Flux Density |
|---|---|
| | [mT] |
| Example | 143 |
| Comparative Example | 118 |
| Reference Example | 118 |

As can be seen from the Table 1, the Example that employed the conductive supporting member 31, made of the magnetic material and thus magnetized, showed an increase in the magnetic flux density as compared with the Comparative Example that employed the conductive supporting member 31 made of the non-magnetic material. The Comparative Example showed the magnetic flux density that was no different from the Reference Example.

### [Experiment 2]

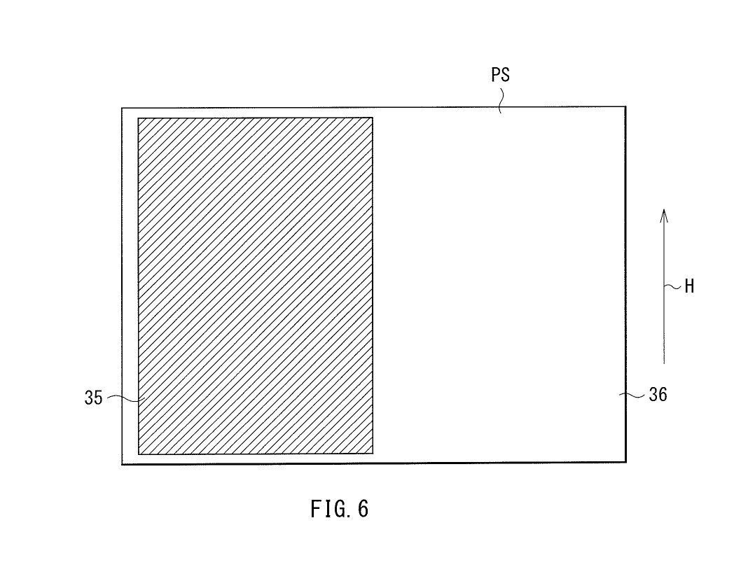

The following evaluation on printing was performed on each of the Example and the Comparative Example described above. The evaluation was performed based on a print state of the printing, that was performed under the print conditions in which: the toner concentration of the image forming unit 1 was adjusted to 8%; A4-size standard paper named “Oki Excellent White Paper” with a weight of 80 g/m² was used for the recording medium PS; a print speed, i.e., the conveying speed of the recording medium PS, was set to 200 mm/sec.; and the duty was 50%, i.e., the printing was performed on a region half the region in which the printing is possible. FIG. 6 schematically illustrates a pattern of the printing performed in the Experiment 2, in which the region half the printing-possible region had been subjected to the printing as a printed part 35. A region excluding the printed part 35 was a non-printed part 36. The recording medium PS was conveyed in a direction denoted by an arrow “H” to be printed. The print conditions also included the following conditions in which: an applied voltage applied to the charging roller 16 was fixed to minus (−) 1146 V at which a surface potential of the photoreceptor drum 15 became −600 V; and an applied voltage applied to the developing sleeve 18 was varied in a range from −300 V to −600 V as shown in Table 2. Also, an intensity of light emission of the LED head 17 was so adjusted as to allow a potential of a latent image on the photoreceptor drum 15 upon the exposure to be −100 V. Table 2 collectively shows each result of the printing evaluation, in which “x” denotes that the print defect was found, and “∘” denotes that no print defect was found.

TABLE 2

| | | Applied Voltage of | | | |
|---|---|---|---|---|---|
| | | Developing Sleeve [V] | | | |
| | | −300 | −400 | −500 | −600 |
| Example | Non-printed Part | ∘ | ∘ | ∘ | ∘ |
| (SUS430) | Printed Part | ∘ | ∘ | ∘ | ∘ |
| Comparative | Non-printed Part | x | ∘ | ∘ | ∘ |
| Example | Printed Part | ∘ | ∘ | ∘ | x |
| (Aluminum) | | | | | |

As can be seen from the Table 2, the print defect was found in the non-printed part 36 when the applied voltage with respect to the developing sleeve 18 was −300 V in the Comparative Example. This is presumably due to the attachment of the magnetic carrier G2 on the photoreceptor drum 15, which resulted in appearance and printing of the toner G1, which had been attached to that magnetic carrier G2, in a region in which the toner layer was supposed not to be formed. Further, the print defect was found in the printed part 35 when the applied voltage with respect to the developing sleeve 18 was −600 V in the Comparative Example. The is presumably due to the attachment of the magnetic carrier G2 on a region, of the photoreceptor drum 15, in which the latent image had been formed, which resulted in a failure in the development at the region in which the magnetic carrier G2 had been attached, and which in turn resulted in occurrence of the voids. Such print defects are both caused by the Coulomb's force, between the developing sleeve 18 and the photoreceptor drum 15, which exceeded the magnetic force of the ferromagnetic member 18M1.

In contrast, no print defect was occurred in the Example irrespective of the magnitude of the applied voltage with respect to the developing sleeve 18. This is presumably due to the magnetic force of the ferromagnetic member 18M1 which exceeded the Coulomb's force that occurred between the developing sleeve 18 and the photoreceptor drum 15, which made it possible to prevent the magnetic carrier G2 from moving toward the photoreceptor drum 15 in the Example.

It was therefore confirmed from the Example as described above that the example embodiment of the invention makes it possible to prevent the attachment of the magnetic carrier G2 on the photoreceptor drum 15, and thereby to prevent the occurrence of the print defect resulting from the magnetic carrier G2 and to achieve higher-quality image.

### 3. Modification Examples

Although the invention has been described in the foregoing by way of example with reference to the example embodiment and the Example, the invention is not limited thereto but may be modified in a wide variety of ways.

For example, the description has been given of the example embodiment in which the image forming unit 1 forms a color image as described above. The invention, however, is not limited thereto, and may be applied to an image forming apparatus that forms a monochrome image. In one embodiment, the image forming apparatus may form the monochrome image through transferring of only a black toner image. Also, the description has been given of the example embodiment in which the image forming unit 1 employs the secondary transfer system as described above, although any embodiment of the invention may be applied to an image forming apparatus that employs a primary transfer system.

A series of processes described in the example embodiment and the modification examples may be performed based on a hardware (such as a circuit) or on a software (such as a program). In one embodiment where the processes are implemented based on the software, the software may contain a group of programs that causes a computer or a machine to execute each function. The programs may be incorporated in the computer or the machine in advance, or may be installed from any network or a storage medium.

The LED head in which light-emitting diodes serve as a light source is used for the exposure unit in the example embodiment and the modification examples. In an alternative embodiment, an exposure unit may be used in which any other light emitting device such as, but not limited to, a laser device is used for the light source.

Also, a description has been given of the example embodiment and the modification examples in which the image forming apparatus having a printing function corresponds to a concrete but non-limiting example of the “image forming apparatus” in one embodiment of the invention. However, the term “image forming apparatus” is not limited to the image forming apparatus having a printing function. Any of the example embodiment and the modification examples described above is applicable to an image forming apparatus that may function as a multi-function peripheral. The multi-function peripheral may include a scanner function, a facsimile function, or both, in addition to the printing function as described above.

Furthermore, the invention encompasses any possible combination of some or all of the various embodiments and the modification examples described herein and incorporated herein.

It is possible to achieve at least the following configurations from the above-described example embodiments of the invention.

(1) An image forming unit, including:

a container configured to contain therein a developer, the developer including a toner and a magnetic carrier;

a developer supporting member including a first magnetic member, and configured to support the developer; and

an image supporting member including a magnetic conductive member and a photosensitive layer, and disposed to face the developer supporting member, the magnetic conductive member including a magnetic material, and the photosensitive layer covering the magnetic conductive member and being configured to support a latent image on a surface of the photosensitive layer.

(2) The image forming unit according to (1), wherein the developer supporting member and the image supporting member face each other and are separated away from each other.
(3) The image forming unit according to (1) or (2), further including a stirring member configured to stir the developer contained in the container.
(4) The image forming unit according to (3), wherein

the developer supporting member further includes a second magnetic member,

the first magnetic member indicates a first polarity at a position that faces the image supporting member, and

the second magnetic member indicates a second polarity opposite to the first polarity at a position that faces the stirring member.

(5) The image forming unit according to any one of (1) to (4), further including:

a charging unit configured to charge a surface of the photosensitive layer; and

an exposure unit configured to perform exposure of the image supporting member to form the latent image.

(6) The image forming unit according to any one of (1) to (4), wherein the magnetic conductive member is a metal pipe.
(7) An image forming apparatus, including:

a print medium feeder configured to feed a print medium; and

the image forming unit according to any one of (1) to (6), and configured to form an image on the print medium fed from the print medium feeder.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

1. An image forming unit, comprising:
a container configured to contain therein a developer, the developer including a toner and a magnetic carrier;
a developer supporting member including a first magnetic member and a second magnetic member, and configured to support the developer;
an image supporting member including a magnetic conductive member and a photosensitive layer, and disposed to face the developer supporting member, the magnetic conductive member including a magnetic material, and the photosensitive layer covering the magnetic conductive member and being configured to support a latent image on a surface of the photosensitive layer; and
a stirring member configured to stir the developer contained in the container, wherein
the first and second magnetic members of the developer supporting member respectively indicate a first polarity at a position that faces the image supporting member and a second polarity opposite to the first polarity at a position that faces the stirring member.

2. The image forming unit according to claim 1, wherein the developer supporting member and the image supporting member face each other and are separated away from each other.

3. (canceled)

4. (canceled)

5. The image forming unit according to claim 1, further comprising:
a charging unit configured to charge the surface of the photosensitive layer; and
an exposure unit configured to perform exposure of the image supporting member to form the latent image.

6. The image forming unit according to claim 1, wherein the magnetic conductive member comprises a metal pipe.

7. An image forming apparatus, comprising:
a print medium feeder configured to feed a print medium; and
an image forming unit configured to form an image on the print medium fed from the print medium feeder, the image forming unit including
a container configured to contain therein a developer, the developer including a toner and a magnetic carrier;
a developer supporting member including a first magnetic member and a second magnetic member, and configured to support the developer;
an image supporting member including a magnetic conductive member and a photosensitive layer, and disposed to face the developer supporting member, the magnetic conductive member including a magnetic material, and the photosensitive layer covering the magnetic conductive member and being configured to support a latent image on a surface of the photosensitive layer; and
a stirring member configured to stir the developer contained in the container, wherein
the first and second magnetic members of the developer supporting member respectively indicate a first polarity at a position that faces the image supporting member and a second polarity opposite to the first polarity at a position that faces the stirring member.

8. The image forming unit of claim 1, wherein
the first magnetic member forms a first magnetic field distribution that attracts the magnetic carrier to the developer supporting member; and
the second magnetic member forms a second magnetic field distribution that attracts the magnetic carrier away from the developer supporting member.

9. The image forming apparatus of claim 7, wherein
the first magnetic member forms a first magnetic field distribution that attracts the magnetic carrier to the developer supporting member; and
the second magnetic member forms a second magnetic field distribution that attracts the magnetic carrier away from the developer supporting member.
